(19) United States
(12) Patent Application Publication
(10) Pub. No.: US 2020/0349198 A1
(43) Pub. Date: Nov. 5, 2020

(54) INFORMATION PRESENTATION DEVICE AND INFORMATION PRESENTATION SYSTEM

(71) Applicant: MITSUBISHI ELECTRIC CORPORATION, Tokyo (JP)

(72) Inventor: Yuko SUGANUMA, Tokyo (JP)

(73) Assignee: MITSUBISHI ELECTRIC CORPORATION, Tokyo (JP)

(21) Appl. No.: 16/963,036

(22) PCT Filed: Jan. 26, 2018
(86) PCT No.: PCT/JP2018/002553

§ 371 Date: Jul. 17, 2020

(51) Int. Cl. G06F 16/9038; G06F 16/901; G06F 16/9035; G06F 16/906

(52) U.S. Cl. CPC G06F 16/9038; G06F 16/906; G06F 16/9035; G06F 16/9024

(57) ABSTRACT

A degree-of-interest calculating unit calculates degrees of interest for each user, for each piece of information in a hierarchical structure, and for each time slot. An execution trigger generating unit generates execution triggers for each user. A graph creating unit creates a graph structure in which text templates having variables are stored in nodes and the nodes are connected by edges, sets weights of the nodes and the edges, and updates the weights of at least one of the nodes and the edges. A presentation content creating unit creates information presenting text by extracting some nodes on the basis of weights of nodes and edges in which degrees of interest of a user and external information set per time slot are reflected in the graph structure, and embedding information determined on the basis of the degrees of interest in the variables of the nodes.

### TECHNICAL FIELD

The present invention relates to an information presentation device that performs information presentation based on degrees of interest for each user, and an information presentation system using the information presentation device.

### BACKGROUND ART

In recent years, there have been techniques for making recommendations by extracting preferences on the basis of a history of personal activities such as a purchase history, a web browsing history, and a television viewing history. Conventionally, for example, Patent Literature 1 discloses a technique for extracting keywords, regarding program viewing using a television set, a smartphone, or the like, that are estimated to be interested by a viewer, from a history of viewing activities, information about viewed programs, etc.

This technique is used for making recommendations when a user is already determined what to achieve (task), such as in a case of presenting recommended programs to a user viewing a program, or in a case of recommending goods to a user browsing an EC site.

### CITATION LIST

### Patent Literatures

Patent Literature 1: JP 2015-215794 A

### SUMMARY OF INVENTION

### Technical Problem

However, when considering provision of information appropriate to individuals in daily life at home, activities performed at home are different among residents, and thus there is a problem that what a user wants to achieve (task) is not clearly uniquely determined like when goods are recommended to a user browsing an EC site.

In addition, it is necessary to provide information that a resident finds useful upon performing information provision, but in activities at home, tasks are not uniquely determined, and information related to everyday life is diverse, e.g., weather, event information, and recipes, and thus, it is considered that the type and granularity of information that residents want are also different depending on the resident or a moment-to-moment situation. Furthermore, information that a resident wants also changes with changes in a life situation. For example, in browsing records of recipe sites, etc., though a resident usually browses elaborate cooking recipes a lot, on a busy week, the resident may brows quick recipes often. In addition, in order for information to be useful, the information needs to be presented at appropriate timing.

As such, conventionally, when information useful for individuals at home is to be provided, it is difficult to guess what information is useful to provide for residents, and there is a problem that it is difficult to provide information that makes the residents feel happy about the information provision.

The invention is made to solve such a problem, and an object of the invention is to provide an information presentation device and an information presentation system that can present information timely in line with each user's activity and in a manner of presentation that attracts users' interest, by guessing information that seems to be useful for each user.

### Solution to Problem

An information presentation device according to the invention includes: a degree-of-interest calculating unit to calculate degrees of interest for each user, for each piece of information in a hierarchical structure, and for each time slot, on the basis of results of analysis of stay time at each node in the hierarchical structure for information obtained when information at each level is presented from a master node to slave nodes in the hierarchical structure; an execution trigger generating unit to generate at least one of a location and an activity serving as a trigger for performing information presentation, as an execution trigger for each user and for each information category; a graph creating unit to create a graph structure in which text templates having variables are stored in nodes and the nodes are connected by edges, set weights of the nodes and the edges, and update the weights of at least one of the nodes and the edges; a situation determining unit to perform determination of whether to perform information presentation, on the basis of the execution trigger and using either one or both of a user's location and activity; a presentation content creating unit to create information presenting text that uses the graph structure constructed by the graph creating unit, by extracting some nodes using the graph structure and on the basis of weights of nodes and edges in which degrees of interest of a user and external information which are set per time slot are reflected, and by embedding, when the extracted nodes include variables, information corresponding to degrees of interest in the variables, and construct a screen configuration corresponding to the created information presenting text; and a presentation unit to perform presentation by voice or on a screen, using the information presenting text created by the presentation content creating unit.

### Advantageous Effects of Invention

The information presentation device according to the invention calculates the degrees of interest for each user, for each piece of information in a hierarchical structure, and for each time slot, on the basis of results of analysis of stay time at each node in the hierarchical structure for information obtained when information at each level is presented from a master node to slave nodes in the hierarchical structure, creates a graph structure in which text templates having variables are stored in nodes and the nodes are connected by edges, sets weights of the nodes and the edges, and updates the weights of at least one of the nodes and the edges, and creates information presenting text that uses a graph structure by extracting some nodes using the graph structure and on the basis of weights of nodes and edges in which the degrees of interest of a user and external information set per time slot are reflected, and embedding, when the nodes include variables, information determined on the basis of the degrees of interest in the variables. Thus, information can be presented timely in line with each user's activity and in a manner of presentation that attracts users' interest.

### BRIEF DESCRIPTION OF DRAWINGS

FIG. 1 is a configuration diagram of an information presentation system of a first embodiment of the invention.

FIG. 2 is a configuration diagram of an information presentation device of the first embodiment of the invention.

FIG. 3 is an explanatory diagram of activity and room related information in the information presentation device of the first embodiment of the invention.

FIG. 4 is an explanatory diagram of an operation log in the information presentation device of the first embodiment of the invention.

FIG. 5 is an explanatory diagram of house and device information in the information presentation device of the first embodiment of the invention.

FIG. 6 is a hardware configuration diagram of the information presentation device of the first embodiment of the invention.

FIG. 7 is a flowchart showing operation of an operation log analyzing unit of the information presentation device of the first embodiment of the invention.

FIG. 8 is an explanatory diagram showing a hierarchical structure of presentation content in the information presentation device of the first embodiment of the invention.

FIG. 9 is a flowchart showing operation of a degree-of-interest calculating unit of the information presentation device of the first embodiment of the invention.

FIG. 10 is a flowchart showing operation of an execution trigger generating unit of the information presentation device of the first embodiment of the invention.

FIG. 11 is an explanatory diagram showing a graph structure in the information presentation device of the first embodiment of the invention.

FIG. 12 is a flowchart showing operation of an initial construction unit of the information presentation device of the first embodiment of the invention.

FIG. 13 is a flowchart showing operation of a weight updating unit of the information presentation device of the first embodiment of the invention.

FIG. 14 is a flowchart showing operation of a situation determining unit of the information presentation device of the first embodiment of the invention.

FIG. 15 is a flowchart showing operation of an information presenting text creating unit of the information presentation device of the first embodiment of the invention.

FIG. 16 is a flowchart showing operation of a presentation unit of the information presentation device of the first embodiment of the invention.

### DESCRIPTION OF EMBODIMENTS

To describe the invention in more detail, an embodiment for carrying out the invention will be described below with reference to the accompanying drawings.

### First Embodiment

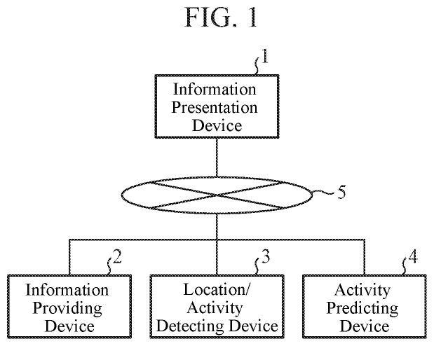

FIG. 1 is a configuration diagram showing an information presentation system of the present embodiment.

The information presentation system shown in the drawing includes an information presentation device 1, an information providing device 2, a location/activity detecting device 3, an activity predicting device 4, and a network 5. The information presentation device 1 estimates information in which a user is interested, on the basis of a user's reaction to information presentation, and presents information presenting text that attracts user's interest, details of which will be described later. Note that the following description is made assuming that the user is a resident in home. The information providing device 2 releases various types of information such as a weather forecast, traffic information, various types of event information, e.g., information about sports and concerts, and exhibitions in art museums, and information about stores and administration to the network 5. The location/activity detecting device 3 detects locations (rooms) and activities (cooking, eating, sleeping, etc.) of residents on the basis of data obtained from devices such as home appliances and light fixtures (data such as open/close of a refrigerator, power on/off of a TV or an air conditioner, and on/off of a lighting fixture) and data from general purpose sensors (a human sensor, a door open/close sensor, a wearable sensor, etc.). For detecting means of the location/activity detecting device 3, various methods can be adopted. For example, when a home appliance operation is performed or an object is sensed by a human sensor, it is considered that a person is present in a corresponding room. When a home application operation is not performed or no object is sensed by the human sensor over a certain period of time or longer from the state when the resident was in the room, it is considered that the person has left the room. In addition, activities are defined in advance so as to be associated with operating conditions of devices such as home appliances, and when a defined device operation is detected, it is assumed that an associated activity is performed. For example, when the television power is turned on, it is assumed to be an activity of television viewing, and when a person is present in a room during night hours and a light fixture in a bedroom is turned off, it is assumed that the person goes to bed. It is configured in such a manner that when a location and an activity of a resident are thus detected and the location or activity is changed, the information after change (location or activity) is associated with a resident ID and transmitted to the information presentation device 1.

The activity predicting device 4 predicts future activities for each resident, on the basis of results of analysis of the past activity log of the residents. For a prediction method, various methods can be adopted. For example, by referring to the past activity log of a target resident and obtaining the most probable activity performed after a given activity, a future activity can be predicted. The activity predicting device 4 is configured in such a manner that the predicted activity is associated with a resident ID and transmitted to the information presentation device 1. The network 5 is provided for connecting the information presentation device 1 to each of the information providing device 2, the location/activity detecting device 3, and the activity predicting device 4, and can be implemented by using wired communication using communication cables, etc., or various types of wireless communication.

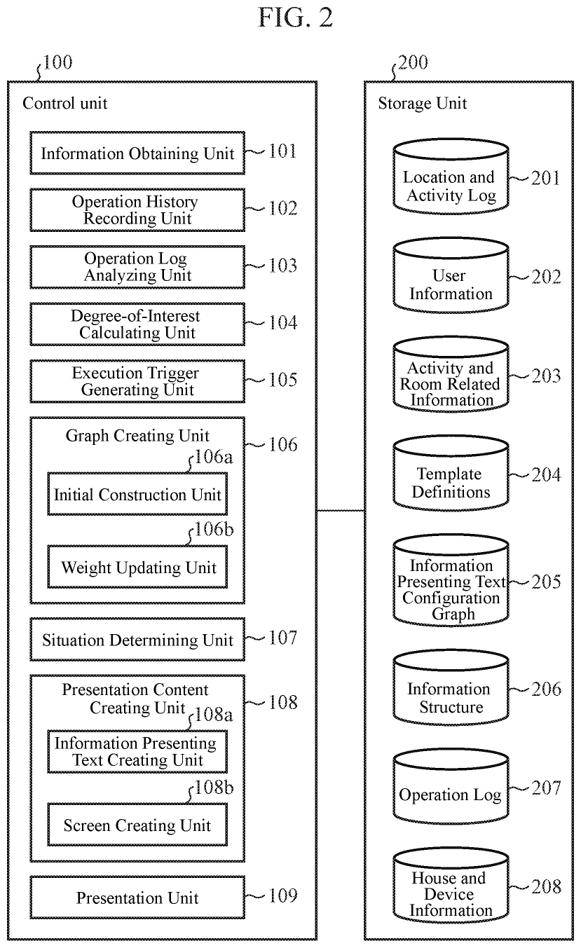

FIG. 2 is a configuration diagram of the information presentation device 1.

As shown in the drawing, the information presentation device 1 includes a control unit 100 and a storage unit 200. The control unit 100 performs control as the information presentation device 1 on the basis of various types of information stored in the storage unit 200, and includes an information obtaining unit 101, an operation history recording unit 102, an operation log analyzing unit 103, a degree-of-interest calculating unit 104, an execution trigger generating unit 105, a graph creating unit 106, a situation determining unit 107, a presentation content creating unit 108, and a presentation unit 109.

The information obtaining unit 101 has a function of obtaining external information released to the network 5 from the information providing device 2, e.g., a weather forecast and event information. In addition, the information obtaining unit 101 has a function of obtaining, from the location/activity detecting device 3, information (information about a location and an activity) changed every time a current location (room) or a current activity of each resident is changed, and accumulating the information as a location and activity log 201 in the storage unit 200 in such a manner that the information is associated with a time and a resident ID. The operation history recording unit 102 is configured to store the contents of operations such as web browsing and television viewing by the residents as an operation log 207 in the storage unit 200. The operation log analyzing unit 103 is configured to separate operations in a log into operations in the log for each resident on the basis of the location and activity log 201 and the operation log 207 which are stored in the storage unit 200, cluster the operations in the log on the basis of time, and output, as results of the analysis of the operation log, results of the analysis performed on the basis of operations performed on screens, such as the number of screen transitions and screen stay time. The degree-of-interest calculating unit 104 is configured to calculate, for each cluster, a total value of stay time at slave nodes connected to the same master node in a hierarchical structure for information, a maximum value of stay time at a given level, etc., on the basis of the results of analysis of the operation log and an information structure 206, and represent the degrees of resident's interest in each piece of information defined in the information structure 206 by numerical values.

The execution trigger generating unit 105 has a function of generating, for each resident, a trigger for performing information presentation (hereinafter, referred to as an execution trigger). The graph creating unit 106 is configured to create a graph structure which includes three layers, an introduction part, a main subject, and a supplement part, and in which text templates having variables are stored in nodes and the nodes are connected by edges, and includes an initial construction unit 106a and a weight updating unit 106b. The initial construction unit 106a is a functional unit that initially constructs a graph structure including nodes and edges, on the basis of text templates stored in the nodes and the arrangement layers, attribute information, weight information, etc., of the nodes. The weight updating unit 106b is a functional unit for updating the weights of the nodes and the edges in the graph structure on the basis of external information such as weather, and the degrees of interest in each piece of information defined in the information structure 206.

The situation determining unit 107 is configured to determine whether to perform information presentation, on the basis of the current location and activity, a log of locations, a predicted future activity, and an execution trigger for a resident. The presentation content creating unit 108 has a function of creating, when the situation determining unit 107 determines to match, information presenting text that uses a graph structure having nodes and edges whose weights are updated by the graph creating unit 106 on the basis of the degrees of interest calculated by the degree-of-interest calculating unit 104 for a current time slot, by extracting a node from the main subject layer using the graph structure, extracting another node connected to the extracted node, as necessary, and embedding, when the nodes include variables, information determined based on the degrees of interest in the variables, and constructing a screen configuration corresponding to the created information presenting text, and includes an information presenting text creating unit 108a and a screen creating unit 108b. The information presenting text creating unit 108a has a function of extracting pieces of text that seem to be useful for a resident, using a graph structure constructed by the graph creating unit 106 and on the basis of the weights of nodes and edges in which the type of information, changing external information (weather, events, etc.), and the degrees of resident's interest are reflected, and creating information presenting text by connecting the pieces of text together. The screen creating unit 108b has a function of constructing a screen configuration of detailed display that is displayed on the presentation unit 109 so as to correspond to the information presenting text created by the information presenting text creating unit 108a. The presentation unit 109 is a functional unit that performs information presentation on the basis of the information presenting text and the screen configuration created by the presentation content creating unit 108.

The storage unit 200 stores, as the information presentation device 1, various types of data that are used by the control unit 100 to perform information presentation, and stores data of a location and activity log 201, user information 202, activity and room related information 203, template definitions 204, an information presenting text configuration graph 205, an information structure 206, an operation log 207, and house and device information 208. The location and activity log 201 is a log of locations and activities received from the location/activity detecting device 3. The location and activity log 201 records rooms (a living room, a kitchen, etc.) in which each resident is currently present and activities (cooking, eating, etc.) of each resident in such a manner that the rooms and the activities are associated with resident IDs and times. The user information 202 is a file that defines, for each resident, information categories which are the types of information that residents want and output destination of information presentation. The information category is information classified by categories, e.g., a weather forecast, traffic information, bargain sale information, event information (sports, exhibitions, local events, etc.), recipes, and recreational information, and categories of information that residents want are defined for each resident. A plurality of information categories can be defined for a single resident. In addition, the information categories can include a category of emergency information. The emergency information is presented at a point in time when the information obtaining unit 101 obtains the emergency information, regardless of an execution trigger of a resident. For the output destination of information presentation, it is specified whether to output to a device (a display, a television set, a speaker, etc.) in home or to a portable device such as a smartphone. Both can also be specified as the output destinations.

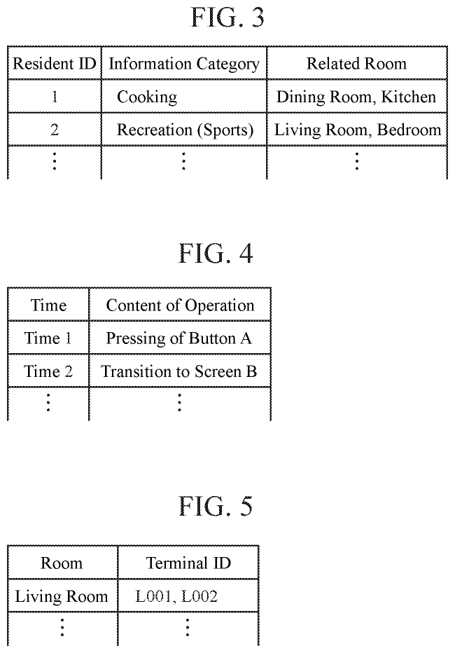

The activity and room related information 203 is a file that defines, for each information category, rooms having terminals (a display, a speaker, etc.) on which information is presented. When the user information 202 defines that the output destination of information presentation is a device in home0, information is presented on a terminal (a display, a speaker, etc.) in a related room defined in the activity and room related information 203. For example, when information about recipes is wanted in relation to the category “cooking”, by defining the activity “cooking” and “kitchen and dining room” in such a manner that they are associated with each other, information about recipes can be presented on a display set up in the kitchen or dining room. The activity and room related information 203 is defined for each resident, and where to receive information can be set to be different between residents even if the information is of the same category. An example of the activity and room related information 203 is shown in FIG. 3.

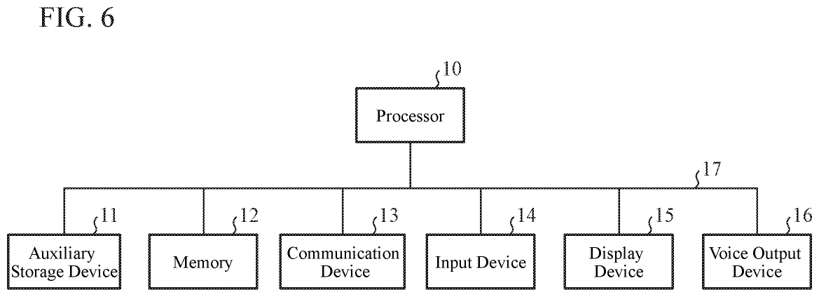

The information presenting text configuration graph 205 is information about a graph structure including nodes and edges which is used to create text (information presenting text) used for simple presentation and is constructed by the graph creating unit 106. The template definitions 204 are files that define information required for initial construction of the information presenting text configuration graph 205. The template definitions 204 define each text template and layers (an introduction part/a main subject/and a supplement) where the text templates are stored, a connection relationship between nodes, attribute information (information defined in the information structure 206, etc.) provided to each node, the initial values of weights, the amounts of weight update, etc. The information structure 206 is a file that defines a hierarchical structure for information. The information structure 206 serves as units of information in which degrees of interest are converted into numerical values by the degree-of-interest calculating unit 104. Upon performing information display, screens are constructed in accordance with the information structure 206, and the degrees of user's interest in information at each level are estimated from a log of user operations on the screens. The operation log 207 is a log (screen transitions, pressing of buttons, etc.) created when a user operates screens upon performing information display. FIG. 4 shows an example of the operation log 207. The content of operation is outputted in such a manner that the content of operation can be grasped, e.g., to which screen a given screen is transitioned or which element (a button, etc.) on a screen is operated. The house and device information 208 is a file that defines association between rooms included in a house and the IDs of information presentation terminals disposed in each room. An example of the house and device information 208 is shown in FIG. 5. Note that the information presentation terminals are a television set, a wall-mounted display, a speaker, etc., and correspond to a display device 15 and a voice output device 16 which will be described with reference to FIG. 6.

FIG. 6 is a hardware configuration diagram of the information presentation device 1 which is the first embodiment of the invention.

As shown in the drawing, the information presentation device 1 includes a processor 10, an auxiliary storage device 11, a memory 12, a communication device 13, an input device 14, the display device 15, and the voice output device 16, and they are communicably connected to each other by a communication channel 17.

The processor 10 is an integrated circuit (IC) that performs processing and is a functional unit that controls the information presentation device 1. The processor corresponds to a central processing unit (CPU), a digital signal processor (DSP), a graphics processing unit (GPU), etc. The auxiliary storage device 11 corresponds, for example, to a ROM, a flash memory, and an HDD, and is a functional unit that stores various types of data. The memory 12 corresponds, for example, to a RAM, and temporarily stores data and forms a work area when the processor 10 performs processes. The communication device 13 is a functional unit that includes communication means such as a wired or wireless LAN or Bluetooth (registered trademark) and performs communication between the information presentation device 1 and the information providing device 2 to the activity predicting device 4. The input device 14 corresponds to input devices used by the residents to input information, e.g., a mouse, a keyboard, and a touch panel. The display device 15 is a device that is, for example, a liquid crystal display (LCD) and that is used to display information presenting text. The voice output device 16 is a device that is, for example, a speaker and that outputs information presenting text by voice. The communication channel 17 corresponds to an internal bus on a computer, or a cable in a case where the display device 15 or the voice output device 16 is defined as an information presentation terminal in another room.

The information obtaining unit 101 to the presentation unit 109 of FIG. 2 are implemented by the processor 10 executing programs corresponding to the respective functional units, and the presentation unit 109 includes the configurations of the display device 15 and the voice output device 16. In addition, the storage unit 200 of FIG. 2 is implemented by the auxiliary storage device 11.

Next, the operation of the information presentation system will be described.

The information obtaining unit 101 of the information presentation device 1 obtains various types of information such as a weather forecast and event information which are released to the network 5 from the information providing device 2. In addition, the information obtaining unit 101 obtains current locations (rooms) of each resident and information (locations and activities) changed every time a current activity changes from the location/activity detecting device 3, and accumulates them as the location and activity log 201 in the storage unit 200 so as to be associated with times and resident IDs.

The operation history recording unit 102 records an operation log (screen transitions, pressing of buttons, etc.) indicating what operations are performed by a resident on various screens displayed on the display device 15 by a display application that performs web display, etc. Namely, the operation history recording unit 102 records information indicating which screen is transitioned to which screen, information indicating on which button on a screen is pressed, etc., with times and stores them as the operation log 207 in the storage unit 200.

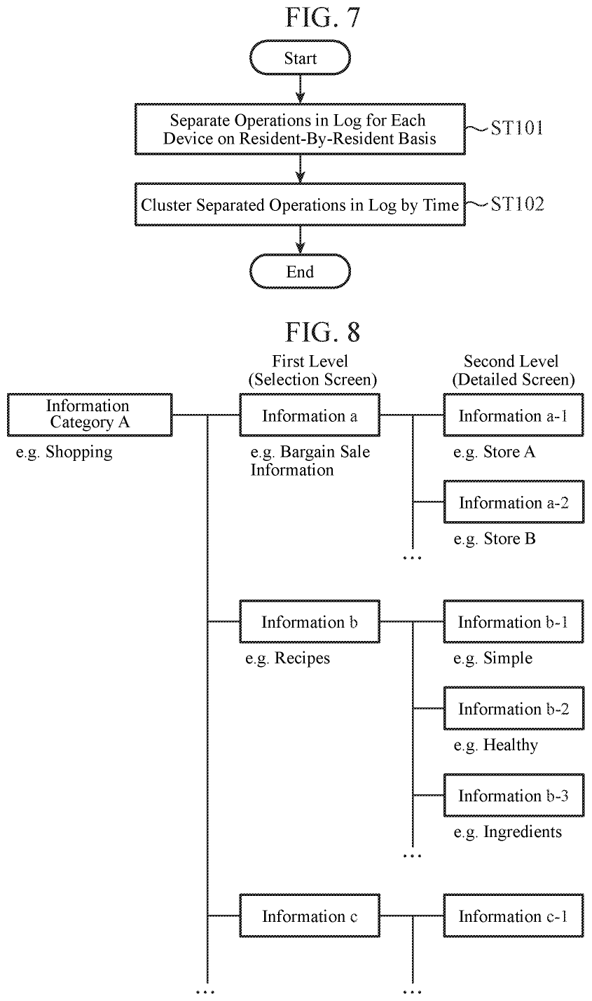

The operation log analyzing unit 103 separates operations in a log into operations in the log for each resident on the basis of the location and activity log 201 and the operation log 207 stored in the storage unit 200, clusters the operations in the log on the basis of time, and outputs analysis results such as the number of screen transitions and screen stay time. FIG. 7 shows a processing flow of the operation log analyzing unit 103.

First, the operation log analyzing unit 103 assumes operations in a log performed on display screens of information presentation terminals present in each room as operations performed by a resident present in the room in which the information presentation terminals are present at the times of the operations in the log, by referring to the location and activity log 201, the operation log 207, and the house and device information 208 stored in the storage unit 200, and associates the operations in the log with the resident ID. When a plurality of residents is present in the same room, a corresponding operation in the log is associated with all residents present in that room (step ST101). Then, the operation log analyzing unit 103 clusters, for each set of operations in the log for each resident, the operations in the log associated with the resident IDs by time and calculates, for each cluster, stay time on each screen, the number of operations, etc. (step ST102).

For example, when operations in a log for a given day are 12:00, 12:10, 12:12, 12:20, 17:15, 17:20, and 17:25, the operations are clustered into two groups “12:00, 12:10, 12:12, 12:20” and “17:15, 17:20, 17:25”.

The operation log analyzing unit 103 stores the operations in the log clustered on the basis of time, as results of analysis of the operation log, in the storage unit 200 in such a manner that the operations are associated with resident IDs, and passes the results of analysis of the operation log to the degree-of-interest calculating unit 104.

When the degree-of-interest calculating unit 104 receives the results of analysis of the operation log from the operation log analyzing unit 103, the degree-of-interest calculating unit 104 calculates, for each cluster, a total value of stay time at slave nodes connected to the same master node in a hierarchical structure for information, a maximum value of stay time at a given level, etc., by referring to the information structure 206 stored in the storage unit 200, and converts the degrees of user's interest in each piece of information defined in the information structure 206 into a numerical value.

For the conversion of the degrees of interest into a numerical value, first, information presented by the display device 15 or the voice output device 16 by a display application will be described. The display application can display detailed information such as recipes. Information presented by the display application is defined by a hierarchical structure such as that shown in FIG. 8 and is stored as the information structure 206 in the storage unit 200. Whether each level corresponds to a selection screen including a plurality of types of information or to a detailed screen for a given single piece of information is also defined. In the presentation by the display application, a transition from gross information to detailed information is made along with a screen transition.

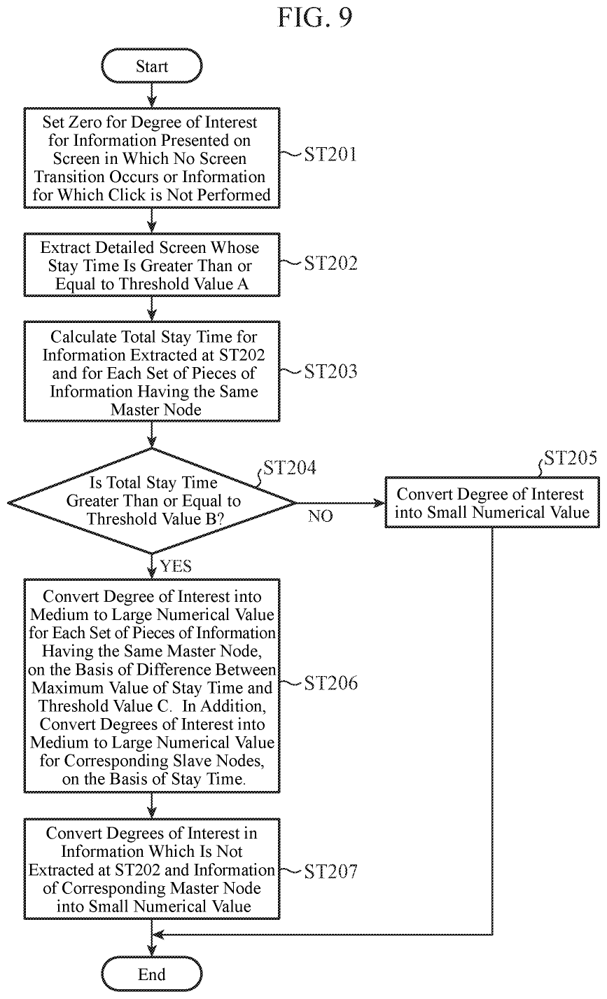

The degree-of-interest calculating unit 104 calculates the degrees of interest in each piece of information shown in the hierarchical structure in FIG. 8, using the results of calculation by the operation log analyzing unit 103. A processing flow of the degree-of-interest calculating unit 104 is shown in FIG. 9.

Note that the following description shows an example in which the degrees of interest are converted into numerical values of five levels, 0.0, 0.25, 0.5, 0.75, and 1.0. Note also that the following three types of threshold values required in the process are manually defined in advance and stored in the storage unit 200.
A threshold value A used at step ST202: a threshold value for stay time on a single screen
A threshold value B used at step ST204: a threshold value for total stay time
A threshold value C used at step ST206: a threshold value for a maximum value of stay time

The degree-of-interest calculating unit 104 first assumes, in the results of analysis obtained from the operation log analyzing unit 103, a screen in which no screen transition occurs or information whose corresponding object on a screen is not operated (a button has not been clicked, etc.) as uninterested and sets “0.0” as zero degree of interest. For example, in the hierarchical structure of FIG. 8, when screens for information c and information in a lower structure thereof (information c-1, etc.) is not operated even once, 0.0 is set for the information c and the information c-1 as zero degree of interest (step ST201).

Then, the degree-of-interest calculating unit 104 extracts a screen which corresponds to detailed information (referred to as detailed screen, and the second level in the case of FIG. 8) in the hierarchical structure for information defined in the information structure 206 and whose stay time is greater than or equal to the threshold value A (step ST202). For example, in a case in which the threshold value is 15 seconds, when screens in the hierarchical structure of FIG. 8 have the following stay times, information a-1 and information a-2 are extracted:

Stay time on a screen for information a-1 (e.g., bargain sale information at store A): 20 seconds

Stay time on a screen for information a-2 (e.g., bargain sale information at store B): 30 seconds

Stay time on a screen for information b-1 (e.g., simple recipes): 5 seconds

Stay time on a screen for information b-2 (e.g., healthy recipes): 8 seconds

Stay time on a screen for information b-3 (e.g., recipes selected on the basis of ingredients): 7 seconds

Then, the degree-of-interest calculating unit 104 calculates total stay time for the information extracted at step ST202 and for each set of pieces of information having the same master node (step ST203). In the above-described example, since the information a-1 is extracted, a sum total of stay time for slave nodes of information a being a master node is calculated. When the slave nodes of the information are two nodes, the information a-1 (bargain sale information at store A) and the information a-2 (bargain sale information at store B), a total of stay time on a screen for the information a-1 and stay time on a screen for the information a-2 is calculated.

Then, the degree-of-interest calculating unit 104 determines whether the total stay time calculated at step ST203 is information showing a value greater than or equal to the threshold value B (step ST204). If, at this step ST204, the total stay time is not greater than or equal to the threshold value B (No in step ST204), the degree of interest is converted into a numerical value corresponding to a small degree of interest (step ST205). When the degree of interest is converted into a numerical value of five levels, 0.0, 0.25, 0.5, 0.75, and 1.0, the value 0.25 is set as a value corresponding to small degree of interest. On the other hand, at step ST204, if the total stay time calculated at step ST203 is information showing a value greater than or equal to the threshold value B (Yes in step ST204), the degree of interest is converted into a numerical value corresponding to medium to large degree of interest for each set of pieces of information having the same master node, on the basis of a difference between a maximum value of stay time and the threshold value C (step ST206). For example, when the degree of interest is converted into a numerical value of five levels, 0.0, 0.25, 0.5, 0.75, and 1.0, the degree of interest in a type of information (first level) whose maximum value of stay time is greater than or equal to the threshold value C is set to 1.0, and the degree of interest in a type of information (first level) whose maximum value is less than the threshold value C is converted into a numerical value corresponding to medium to large degree of interest, on the basis of the magnitude of a difference between the maximum value and the threshold value. In addition, for the information of each of its slave nodes, the degree of interest is converted into a numerical value corresponding to medium to large degree of interest on the basis of the screen stay time.

At step ST204, since the stay time on the screen for the information a-1 is 20 seconds and the stay time on the screen for the information a-2 is 30 seconds, their total is 50 seconds, and when the threshold value B is defined to be 30 seconds, the total is greater than or equal to the threshold value B, and thus, processing transitions to step ST206. The master node is “information a” and the maximum value of stay time corresponds to the information a-2. When the threshold value C is defined to be 20 seconds, the degree of interest in the information a is 1.0. In addition, the degrees of interest in the information a-1 and the information a-2 are, for example, 0.75 and 1.0, respectively.

In addition, for information that is not extracted at step ST202, the degree-of-interest calculating unit 104 converts it into a numerical value corresponding to small degree of interest (step ST207). In the above-described example, such information corresponds to information b-1, information b-2, information b-3, and information b. For the numerical value of the degree of interest, for example, the degree of interest in each of those pieces of information is represented by 0.25.

In this manner, the degree-of-interest calculating unit 104 converts, for each cluster generated by the operation log analyzing unit 103, the degree of interest in each piece of information into a numerical value for the hierarchical structure for each piece of information defined in the information structure 206 (FIG. 8). Since the conversion into a numerical value is performed on a cluster-by-cluster basis, even if information is of the same type, different degrees of interest are set for different residents and different time slots. For example, when the operation log analyzing unit 103 clusters operations in a log for a given information presentation terminal for the resident ID=1 into two groups, “12:00, 12:10, 12:12, 12:20” and “17:15, 17:20, 17:25”, results of output from the degree-of-interest calculating unit 104 for the resident ID=1 are of two types, results for the time slot 12:00 to 12:20 and results for the time slot 17:15 to 17:25.

The results of numerical conversion of the degrees of interest by the degree-of-interest calculating unit 104 are stored as a numerical conversion information structure in the storage unit 200 so as to be associated with resident IDs and time slots in the above-described manner, and are passed to the graph creating unit 106.

The execution trigger generating unit 105 generates, for each resident, a trigger (referred to as execution trigger) for performing information presentation. The execution trigger is of three types, (A) a location, (B) an activity, and (C) both the location and the activity, and any of (A) to (C) is defined for each information category in advance in a file and stored in the storage unit 200.

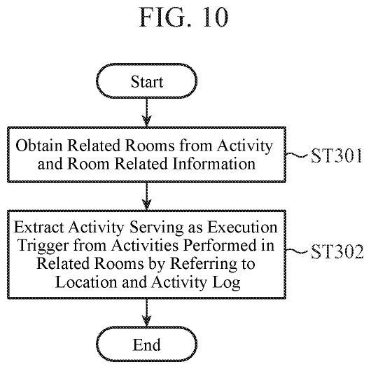

A flow of a process performed by the execution trigger generating unit 105 for a case of an information category in which an activity is defined as an execution trigger (=(B)) is shown in FIG. 10.

The execution trigger generating unit 105 first obtains information on related rooms associated with a target information category from the activity and room related information 203 stored in the storage unit 200 (step ST301). For example, when, as shown in FIG. 3, the dining room and the kitchen are associated as related rooms with the information category “cooking” in the activity and room related information 203, the dining room and the kitchen are obtained as information on related rooms.

Then, the execution trigger generating unit 105 extracts an activity which was performed at a time closest to a time at which an activity corresponding to the information category was performed among activities performed in the rooms obtained at step ST301 in the past activities of a target resident by referring to the location and activity log 201 stored in the storage unit 200 (step ST302). For example, when recipes are presented in relation to a cooking activity, the information category is “cooking”. When the kitchen and the dining room are defined as rooms significantly related to the cooking activity in the activity and room related information 203, as another activity which was performed at a time closest to a time at which the cooking activity was performed among activities performed in the kitchen and the dining room, for example, the activity “television viewing” is generated as an execution trigger.

On the other hand, in a case of an information category whose execution trigger is a location (=(A)), a location (room) serving as an execution trigger is defined. For example, when, in a case of a bad weather, a resident is reminded to take an umbrella when he/she comes to an entrance, the entrance is defined as a location trigger. In addition, for the information category “emergency information” such as traffic information, by setting all rooms as a location trigger, whichever room a resident is present in, emergency information can be received.

In addition, for a case in which the execution trigger is both the location and the activity (=(C)), for example, there is a case in which bargain sale information is presented in relation to the activity of going shopping at a supermarket. In this case, the information category is “shopping (going out)”, and when the kitchen and the dining room are defined as rooms related to the information category “shopping (going out)” in the activity and room related information 203, as another activity which was performed at a time closest to a time at which the shopping (going out) activity was performed among activities performed in the kitchen or the dining room, for example, the activity “washing the dishes after eating” serves as an execution trigger. In addition, the entrance is set as a location trigger so that a resident can be reminded to take an umbrella in a case of a bad weather.

As such, since the execution trigger generating unit 105 determines an execution trigger (activity) from the past activities of a target resident on the basis of the location and activity log 201, even for the same information category, different execution triggers are determined for different residents. The thus generated execution triggers are stored as execution trigger information, which is not shown in the storage unit 200, and passed to the graph creating unit 106 and the situation determining unit 107.

The graph creating unit 106 constructs a graph structure (including nodes and edges) used to create text (hereinafter, information presenting text) that concisely describes a summary of presentation content upon information presentation. The graph structure is constructed for each resident.

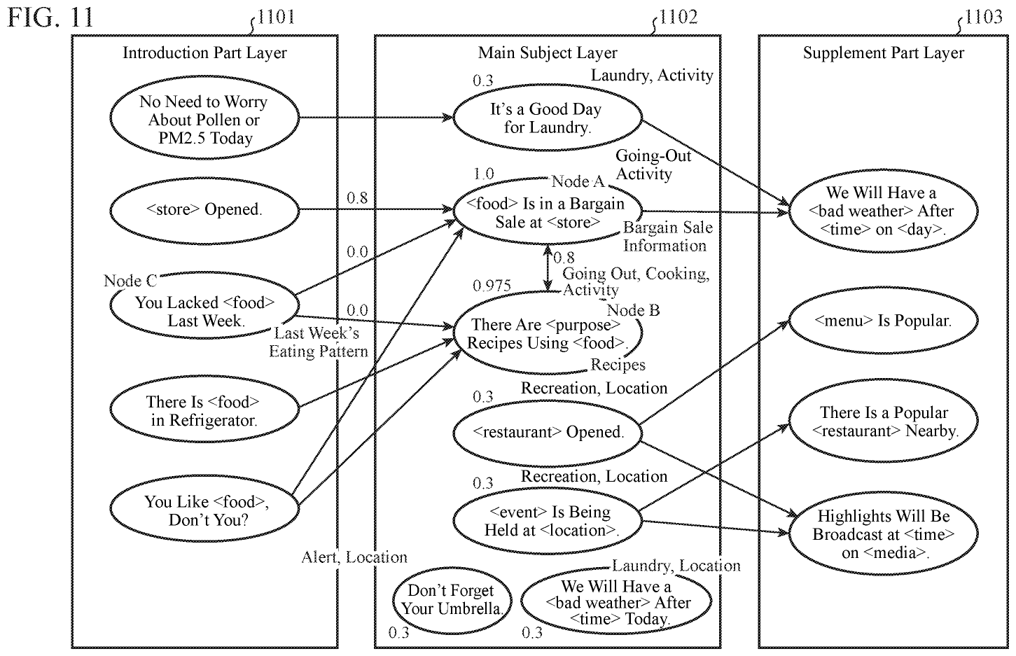

FIG. 11 shows an example of a graph structure. The graph structure includes three layers, an introduction part layer 1101, a main subject layer 1102, and a supplement part layer 1103. Each layer stores text templates in accordance with information categories (cooking, recreation, etc.). The parts indicated by < > are variables. Nodes and edges have weights. In the following example, only nodes in the main subject layer 1102 have node weights.

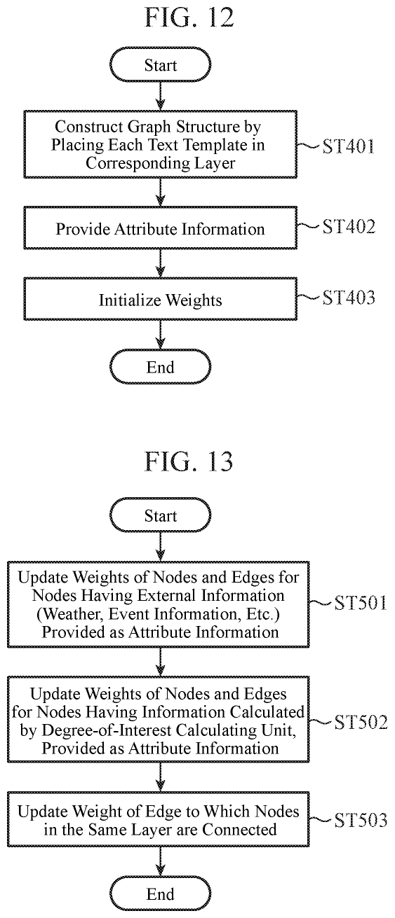

In the graph creating unit 106, the initial construction unit 106a constructs a graph structure on the basis of each text template and layers (the introduction part layer 1101/the main subject 1102 layer/and the supplement part layer 1103) where the text templates are stored, and the template definitions 204 in which attribute information is defined, and performs provision of attributes and initialization of weights. A processing flow of the initial construction unit 106a is shown in FIG. 12.

The initial construction unit 106a first places each of the defined text templates in a corresponding layer (the introduction part layer 1101/the main subject layer 1102/and the supplement part layer 1103) on the basis of the template definitions 204, and connects nodes having a connection relationship by edges (step ST401). A determination as to whether nodes have a connection relationship is made on the basis of the following:
Nodes having common variables which are included in text templates of the nodes
Nodes whose connection is defined in the template definitions 204

For example, when a text template of a given node N1 includes a variable <food> and a text template of a given node N2 also includes a variable <food>, the node N1 is connected to the node N2 by an edge. In addition, even if nodes do not have common variables, when a connection relationship thereof is defined in the template definitions 204, the nodes are connected by an edge. It is also possible to connect nodes in the same layer by an edge.

Then, when the initial construction unit 106a receives execution triggers for a processing target resident from the execution trigger generating unit 105 by referring to the user information 202, the information structure 206, and the template definitions 204, the initial construction unit 106a provides information categories and the execution triggers (locations and activities) as attribute information to nodes in the main subject layer 1102 (step ST402).

In addition, information defined in the information structure 206 is provided as attribute information to corresponding nodes. For example, when “bargain sale information” (the information a of FIG. 8) is associated with the node “<food> is in a bargain sale at <store>.” in the main subject layer 1102 of FIG. 11 in the template definitions 204, “bargain sale information” (the information a of FIG. 8) is provided as attribute information to attribute information of the node “<food> is in a bargain sale at <store>.”.

In addition, when external information such as a weather forecast is provided as attribute information in the template definitions 204, the external information of a weather forecast is provided as attribute information to the node (“We will have a <bad weather> after <time> today.”, etc.) related to weather of FIG. 11.

Then, the initial construction unit 106a sets initial values of weights for the nodes in the main subject layer 1102 and other edges on the basis of the template definitions 204 (step ST403).

The graph structure constructed by the initial construction unit 106a is stored in the storage unit 200, and the weights of the nodes and the edges are updated by the weight updating unit 106b.

The weight updating unit 106b of the graph creating unit 106 updates the weights of the nodes and the edges on the basis of external information (weather and events) obtained by the information obtaining unit 101 and the degrees of interest in each piece of information which are defined in a numerical conversion information structure calculated by the degree-of-interest calculating unit 104. A processing flow of the weight updating unit 106b is shown in FIG. 13.

The weight updating unit 106b first updates the weights of nodes and edges for nodes having external information (weather, event information, etc.) provided as attribute information (step ST501). For example, on the basis of the amounts of node weight update defined in the template definitions, in a case of a bad weather, the values of the node “We will have a <bad weather> after <time> today.” and the node “Don't forget your umbrella” are increased, and in a case of a good weather, the weights of those nodes are reduced. In a case of nodes having event information provided as an attribute, the weight of a corresponding node is increased when an event is being held, and the weight of the corresponding node is reduced when the event period has passed.

Then, the weight updating unit 106b updates the weights of nodes and edges for nodes to which a numerical conversion information structure calculated by the degree-of-interest calculating unit 104 is provided as attribute information (step ST502). Since the degree-of-interest calculating unit 104 converts, for each cluster generated by the operation log analyzing unit 103, the degrees of interest in each piece of information to be outputted by the display device 15 or the voice output device 16 into numerical values, the weights of nodes and edges are updated on the basis of results of numerical conversion of the degrees of interest for a cluster corresponding to the current time on the basis of results of clustering.

Specifically, nodes in the main subject layer 1102 associated with pieces of information whose degrees of interest are greater than or equal to a threshold value are extracted on the basis of the degrees of interest in each piece of information calculated by the degree-of-interest calculating unit 104, the amounts of weight update defined in the template definitions 204 are allocated on the basis of the magnitude of the degree of interest, and the values are increased from the current node weights. Furthermore, the weights of edges (edges between the main subject layer 1102 and the introduction part layer 1101 and edges between the main subject layer 1102 and the supplement part layer 1103) connected to the nodes whose weights are increased are increased by predetermined amounts (values defined in the template definitions 204). In addition, the weights of nodes in the main subject layer 1102 and edges associated with pieces of information whose degrees of interest are less than or equal to the threshold value are reduced.

Then, the weight updating unit 106b updates the weight of an edge to which nodes in the same layer are connected (step ST503). For example, when, as shown in FIG. 11, nodes in the main subject layer 1102 include the same variable, the nodes in the main subject layer 1102 are connected to each other. In such a case in which nodes in the same layer are connected to each other, when the weights of both nodes are changed at step ST502, the weight of the edge connecting the nodes is changed. When the weights of nodes at both ends are increased at step ST502, the weight of the edge connecting the nodes is increased by the amount of change defined in the template definitions 204, and when the weights of nodes at both ends are reduced at step ST502, the weight of the edge connecting the nodes is reduced by the amount of change defined in the template definitions 204.

FIG. 11 shows an example of weights in a case where the degrees of interest in each piece of information which are calculated by the degree-of-interest calculating unit 104 are as follows:

Bargain sale information (information a): 1.0, recipes (information b): 0.75, and last week's eating pattern (information c): 0.0

The initial value of the node weight of the main subject layer 1102 is 0.3, and only those edges whose weights are changed are described.

The results of an update of the weights made by the weight updating unit 106b in the above-described manner are reflected in the graph structure stored in the storage unit 200.

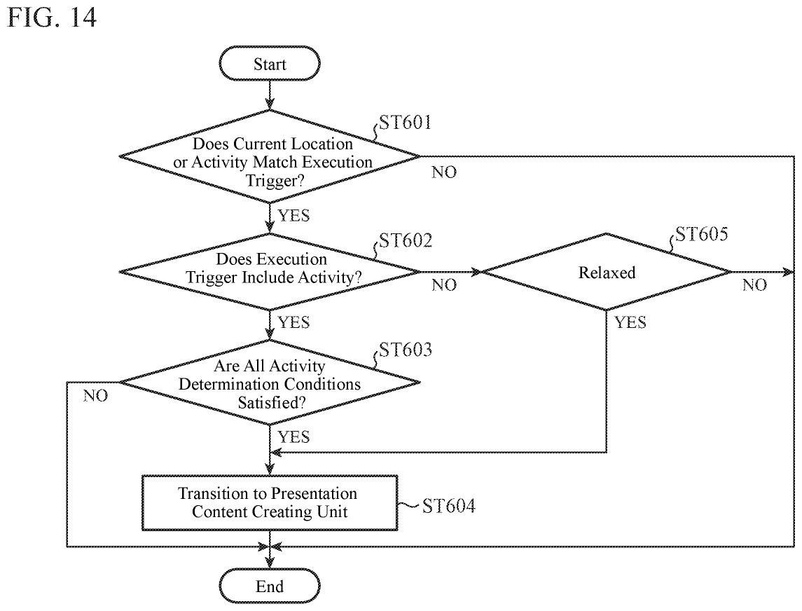

The situation determining unit 107 determines whether to perform information presentation, on the basis of the current location and activity, a log of locations, a predicted future activity, and an execution trigger. A processing flow of the situation determining unit 107 is shown in FIG. 14.

When the information obtaining unit 101 obtains the current location and activity from the location/activity detecting device 3, the situation determining unit 107 determines whether the current location or activity matches an execution trigger generated by the execution trigger generating unit 105 (step ST601). If they match (Yes in step ST601), processing proceeds to step ST602, and furthermore if the execution trigger includes an activity (Yes in step ST602), processing proceeds to step ST603, and at step ST603 it is determined whether all activity determination conditions are satisfied. Here, the activity determination conditions are, for example, as follows:
(a) The current location or activity matches the execution trigger.
(b) An activity of an information category for the execution trigger is predicted as a future activity.

As an example, a case of determining whether to perform information presentation related to shopping will be described. The information category is shopping (going out).

It is assumed that “washing the dishes after eating” is generated as an execution trigger for the information category “shopping (going out)” for a given resident (which is resident 1) by the execution trigger generating unit 105. In this case, when the current activity received by the information obtaining unit 101 is “washing the dishes after eating”, the condition of the above-described (a) is satisfied. For (b), in the case of this example, when the activity “shopping (going out)” is received as a future prediction activity, (b) is satisfied.

If (a) and (b) are all satisfied (Yes in step ST603), processing transitions to step ST604, and processing transitions to a process performed by the presentation content creating unit 108 which will be described later.

On the other hand, if, at step ST602, the execution trigger does not include an activity (No in step ST602), i.e., if the execution trigger is a location, processing transitions to step ST605, and at step ST605 it is determined whether the resident is currently not in a busy situation (whether the resident is relatively relaxed). For a determination method, for example, by referring to a location log for a current processing target resident (in this case, the resident 1), the number of times the resident 1 moved between rooms (represented as the number of movements a) during a period of time from the current time back to a predetermined period of time (e.g., 30 minutes) and the number of times the resident 1 moved between rooms (represented as the number of movements b) during a period of time from that time further back to the predetermined period of time are calculated, and when the number of movements a is smaller than the number of movements b, it is determined that the resident 1 is not in a busy situation.

If the resident is not in a busy situation (Yes in step ST605), processing transitions to step ST604 and transitions to a process performed by the presentation content creating unit 108 which will be described later. If the resident is in a busy situation (No in step ST605), the process by the situation determining unit 107 ends. Note that when, at the above-described step ST601, the current location or activity does not match the execution trigger generated by the execution trigger generating unit 105 (No in step ST601) and when, at step ST603, neither (a) or (b) is satisfied (No in step ST603), processing ends.

Although the above description shows an example of (a) and (b) as activity determination conditions, in addition thereto, the conditions may include whether a resident is not in a busy situation as in a case in which a location is an execution trigger. Further, other conditions may be included.

In addition, for a method of determining whether the resident is not in a busy situation (whether the resident is relatively relaxed), there is shown a method in which the determination is made using the number of times the resident moved between rooms on the basis of the location log, but the determination method is not limited to the one described above.

The presentation content creating unit 108 creates information presenting text that is presented on the presentation unit 109, using an information presenting text configuration graph with attribute information which is constructed by the graph creating unit 106.

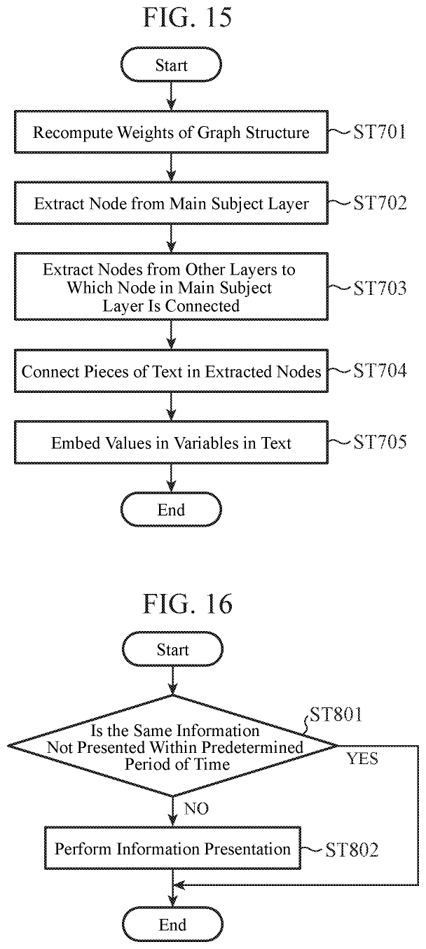

In the presentation content creating unit 108, the information presenting text creating unit 108a creates information presenting text to be simply presented, on the basis of a graph structure. A processing flow of the information presenting text creating unit 108a is shown in FIG. 15.

The information presenting text creating unit 108a updates weights on the basis of results of numerical conversion of the degrees of interest for the current time among results of numerical conversion of the degrees of interest in each piece of information which are defined in the information structure 206 by a process performed by the weight updating unit 106b of the graph creating unit 106. In addition, for nodes related to external information such as weather and event information, the weights of the nodes and edges are updated. Namely, the weights of the graph structure are recomputed (step ST701). Then, the information presenting text creating unit 108a extracts a node from the main subject layer 1102 in a manner shown below (step ST702).

First, by referring to attributes (execution triggers, information categories, etc.) associated with nodes in the main subject layer 1102, nodes whose execution triggers and information categories provided as attributes match the execution triggers and information categories of a processing target resident are extracted. Then, of the extracted nodes, a node with the largest node weight is extracted. In addition, when the main subject layer 1102 includes another node connected to the node with the largest node weight, a node that has an edge connected to that node whose weight is greater than or equal to a threshold value is extracted.

Subsequently, the information presenting text creating unit 108a extracts nodes from other layers (the introduction part layer 1101 and the supplement part layer 1103) connected to the node in the main subject layer 1102 (step ST703). Specifically, from each of the introduction part layer 1101 and the supplement part layer 1103 connected to the node in the main subject layer 1102 extracted at step ST702, an edge with the largest edge weight is selected from among edges connected to the node in the main subject layer 1102 extracted at step ST702, and a node (nodes in the introduction part layer 1101 and the supplement part layer 1103) connected to the edge is extracted. Furthermore, the information presenting text creating unit 108a connects pieces of text stored in the nodes extracted at step ST702 and step ST703 in order of the introduction part, the main subject, and the supplement part (step ST704). When nodes are connected to each other in the main subject layer 1102 and are extracted, two pieces of text from the main subject layer 1102 are connected.

Then, the information presenting text creating unit 108a substitutes values in variables embedded in text templates stored in the nodes (step ST705). For the values to be substituted, a value of corresponding information having the largest numerical value of weight is substituted on the basis of information provided as an attribute to a node and the results of weights calculated by the degree-of-interest calculating unit 104. For example, in FIG. 11, the information a (bargain sale information) in the hierarchical structure for information of FIG. 8 is provided as attribute information to a node A (“<food> is in a bargain sale at <store>.”) in the drawing. Hence, of the information a-1 and the information a-2 which are slave nodes of the information a, the information having a larger value which is obtained by conversion into a numerical value by the degree-of-interest calculating unit 104 is substituted in the variable <store>. For example, when the degree of interest in the information a-1 (store A) is 1.0 and the degree of interest in the information a-2 (store B) is 0.75, “store A” is substituted in <store>. When external information such as weather is associated as attribute information with a node, the information obtaining unit 101 obtains external information such as the time at which rain falls from the information providing device 2, and a value is embedded on the basis of the obtained information. Which information is associated with each variable in text is defined in the template definitions 204. Note that when there remains text in which a value is not set for a variable in a text template, the text is omitted.

The information presenting text thus created is stored in the storage unit 200 and passed to the presentation unit 109 as presentation content for simple presentation.

In the presentation content creating unit 108, the screen creating unit 108b creates a screen configuration for detailed presentation which is to be displayed on the presentation unit 109, so as to be appropriate to the information presenting text created by the information presenting text creating unit 108a. For example, content to be displayed on a top screen is changed on the basis of the text created by the information presenting text creating unit 108a. As an example, in a case in which, as shown in FIG. 8, there are two types of information, bargain sale information and recipes, when the information presenting text creating unit 108a created “Vegetables are in a bargain sale at store ◯ Δ.” as text related to the bargain sale information, a screen configuration is constructed in such a manner that a screen about bargain sale information of store ◯ Δ is a top screen.

In addition, screen elements are constructed so as to distinguish a portion that is the main subject in the text from a supplementary portion, by making font size larger or making fonts blink or bold upon screen display on the basis of the structure of the text created by the information presenting text creating unit 108a. For example, when text including a main subject and a supplement part is created by the information presenting text creating unit 108a, screen UI elements are constructed to provide display such as that shown below.
The characters in the main subject are large and the characters in the supplement part are a bit small.
Only the text in the main subject is displayed blinking.

The screen configuration created by the screen creating unit 108b is stored in the storage unit 200 and passed to the presentation unit 109.

When the presentation unit 109 receives the information presenting text from the information presenting text creating unit 108a and receives the screen configuration from the screen creating unit 108b, the presentation unit 109 performs information presentation when a certain condition is satisfied. A processing flow of the presentation unit 109 is shown in FIG. 16.

The presentation unit 109 first checks whether the received information presenting text was presented within a predetermined period of time (step ST801). If information presentation was performed (No in step ST801), the information presenting text at that time is stored in the storage unit 200 so as to be associated with a resident ID and a time. On the basis of this record, the currently received information presenting text, and a resident ID, it is determined whether the same information presenting text was already presented to the same resident within the predetermined period of time. If the currently received information presenting text was not presented to the target resident (Yes in step ST801), information presentation is performed (step ST802). Specifically, by referring to the activity and room related information 203 and the house and device information 208 stored in the storage unit 200, an ID of an information presentation terminal present in a room in which the resident is currently present among rooms associated with a current target information category is obtained, and the received information is presented to the obtained terminal ID. The information presenting text used for simple presentation is presented by the display device 15 or the voice output device 16. Detailed presentation is displayed on the display device 15.

Although in the first embodiment, an example is shown in which information is presented using information presentation terminals (a display, a television set, a speaker, etc.) present in home, when a resident carries a mobile terminal such as a smartphone, information may be presented on the mobile terminal. In that case, the mobile terminal is specified as the output destination of information presentation in the user information 202 stored in the storage unit 200.

Although in the first embodiment, an example is shown in which the degree-of-interest calculating unit 104 converts the degree of interest into a numerical value of five levels, 0.0, 0.25, 0.5, 0.75, and 1.0, the numerical value of the degree of interest is not limited to the above-described five levels of numerical values. In addition, even if the number of levels is five, numerical values other than those described above may be used, or the number of levels does not need to be five. Furthermore, the magnitudes of the degrees of interest may be converted into a numerical value using continuous values instead of being discretized.

Although in the first embodiment, the graph of FIG. 11 is shown as a graph structure created by the graph creating unit 106, the graph structure is constructed on the basis of the template definitions 204, and the contents, variables, etc., of text which form a template can be freely defined. Namely, the graph structure is not limited to the example of FIG. 11. In addition, although, as a graph structure, an example of a graph structure including three layers, an introduction part, a main subject, and a supplement part, is shown, the graph structure is not limited to three layers structure.

Although in the first embodiment, an example is shown in which in the graph structure only the main subject layer 1102 has node weights, nodes in other layers may also have weights. In this case, in FIG. 15 showing the processing flow of the information presenting text creating unit 108a, at step ST703, from each of the introduction part layer 1101 and the supplement part layer 1103 connected to the node in the main subject layer 1102 extracted at step ST702, an edge with the largest edge weight is selected from among edges connected to the node in the main subject layer 1102, and a node (nodes in the introduction part layer 1101 and the supplement part layer 1103) connected to the edge is extracted, and then, for example, only a node whose weight is greater than or equal to a threshold value is further extracted, by which the degree of extraction of information can be changed.

Although in the first embodiment the information presentation system is described using a configuration including the activity predicting device 4, when an execution trigger represents information on a location in the information presentation device 1, a configuration without the activity predicting device 4 may be adopted.

Although in the first embodiment a hierarchical structure for information is described using FIG. 8, the number of levels is not limited to two, and any levels can be defined.

Note that although an example in which the location/activity detecting device 3 detects both a location and an activity is described, only either one of them may be detected and the information presentation device 1 may create presentation content on the basis of that information.

As described above, an information presentation device of the first embodiment includes a degree-of-interest calculating unit to calculate degrees of interest for each user, for each piece of information in a hierarchical structure, and for each time slot, on the basis of results of analysis of stay time at each node in the hierarchical structure for information obtained when information at each level is presented from a master node to slave nodes in the hierarchical structure; an execution trigger generating unit to generate at least one of a location and an activity serving as a trigger for performing information presentation, as an execution trigger for each user and for each information category; a graph creating unit to create a graph structure in which text templates having variables are stored in nodes and the nodes are connected by edges, set weights of the nodes and the edges, and update the weights of at least one of the nodes and the edges; a situation determining unit to perform determination of whether to perform information presentation, on the basis of the execution trigger and using either one or both of a user's location and activity; a presentation content creating unit to create information presenting text that uses the graph structure constructed by the graph creating unit, by extracting some nodes using the graph structure and on the basis of weights of nodes and edges in which degrees of interest of a user and external information which are set per time slot are reflected, and by embedding, when the extracted nodes include variables, information corresponding to degrees of interest in the variables, and construct a screen configuration corresponding to the created information presenting text; and a presentation unit to perform presentation by voice or on a screen, using the information presenting text created by the presentation content creating unit. Thus, information can be presented timely in line with each user's activity and in a manner of presentation that attracts users' interest.

In addition, according to the information presentation device of the first embodiment, the situation determining unit performs the determination on the basis of a predicted user's future activity. Thus, information presentation more useful for the users can be performed.

In addition, according to the information presentation device of the first embodiment, the graph creating unit includes an initial construction unit to initially construct the graph structure using the text templates; and a weight updating unit to weight the nodes and the edges on the basis of external information. The presentation content creating unit includes an information presenting text creating unit to construct a screen configuration corresponding to the created information presenting text, and create, as a presentation content, the information presenting text including external information; and a screen creating unit to construct the screen configuration corresponding to the information presenting text. The presentation unit performs the presentation using the screen configuration constructed by the presentation content creating unit. Thus, information presentation that matches users' interest can be performed.

In addition, according to the information presentation device of the first embodiment, the graph structure includes three layers which are an introduction part, a main subject, and a supplement part. The presentation content creating unit creates the information presenting text by combining nodes in the three layers on the basis of a type of information. Thus, information presenting text useful for the users can be created.

In addition, an information presentation system of the first embodiment includes a location/activity detecting device to perform detection of at least one of a location and an activity for each user; and an information presentation device to present information using results of the detection by the location/activity detecting device. The information presentation device includes: a degree-of-interest calculating unit to calculate degrees of interest for each user, for each piece of information in a hierarchical structure, and for each time slot, on the basis of results of analysis of stay time at each node in the hierarchical structure for information obtained when information at each level is presented from a master node to slave nodes in the hierarchical structure; an execution trigger generating unit to generate at least one of a location and an activity serving as a trigger for performing information presentation, as an execution trigger for each user and for each information category; a graph creating unit to create a graph structure in which text templates having variables are stored in nodes and the nodes are connected by edges, set weights of the nodes and the edges, and update the weights of at least one of the nodes and the edges; a situation determining unit to perform determination of whether to perform information presentation, on the basis of the execution trigger and using either one or both of the location and activity detected by the location/activity detecting device; a presentation content creating unit to create information presenting text that uses the graph structure constructed by the graph creating unit, by extracting some nodes using the graph structure and on the basis of weights of nodes and edges in which degrees of interest of a user and external information which are set per time slot are reflected, and by embedding, when the extracted nodes include variables, information corresponding to degrees of interest in the variables, and construct a screen configuration corresponding to the created information presenting text; and a presentation unit to perform presentation by voice or on a screen, using the information presenting text created by the presentation content creating unit. Thus, information can be presented timely in line with each user's activity and in a manner of presentation that attracts users' interest.

In addition, an information presentation system of the first embodiment includes a location/activity detecting device to perform detection of at least one of a location and an activity for each user; an activity predicting device that perform calculation of predicted future activities for each user; and an information presentation device to present information using results of the detection by the location/activity detecting device and results of the calculation by the activity predicting device. The information presentation device includes: a degree-of-interest calculating unit to calculate degrees of interest for each user, for each piece of information in a hierarchical structure, and for each time slot, on the basis of results of analysis of stay time at each node in the hierarchical structure for information obtained when information at each level is presented from a master node to slave nodes in the hierarchical structure; an execution trigger generating unit to generate at least one of a location and an activity serving as a trigger for performing information presentation, as an execution trigger for each user and for each information category; a graph creating unit to create a graph structure in which text templates having variables are stored in nodes and the nodes are connected by edges, set weights of the nodes and the edges, and update the weights of at least one of the nodes and the edges; a situation determining unit to perform determination of whether to perform information presentation, on the basis of the execution trigger and using at least one of the location and activity detected by the location/activity detecting device and the predicted future activities calculated by the activity predicting device; a presentation content creating unit to create information presenting text that uses the graph structure constructed by the graph creating unit, by extracting some nodes using the graph structure and on the basis of weights of nodes and edges in which degrees of interest of a user and external information which are set per time slot are reflected, and by embedding, when the extracted nodes include variables, information corresponding to degrees of interest in the variables, and construct a screen configuration corresponding to the created information presenting text; and a presentation unit to perform presentation by voice or on a screen, using the information presenting text created by the presentation content creating unit. Thus, information presentation more useful for the users can be performed.

In addition, according to the information presentation system of the first embodiment, the graph creating unit includes an initial construction unit to initially construct the graph structure using text templates; and a weight updating unit to weight the nodes and the edges on the basis of external information. The presentation content creating unit includes an information presenting text creating unit to construct a screen configuration corresponding to the created information presenting text, and create, as a presentation content, the information presenting text including external information; and a screen creating unit to construct the screen configuration corresponding to the information presenting text. The presentation unit performs the presentation using the screen configuration constructed by the presentation content creating unit. Thus, information presentation that matches users' interest can be performed.

In addition, according to the information presentation system of the first embodiment, the graph structure includes three layers which are an introduction part, a main subject, and a supplement part. The presentation content creating unit creates a presentation content by combining nodes in the three layers on the basis of a type of information. Thus, information presenting text useful for the users can be created.

Note that in the invention of the present application, modifications to any component of an embodiment or omissions of any component of an embodiment are possible within the scope of the invention.

### INDUSTRIAL APPLICABILITY

As described above, an information presentation device and an information presentation system according to the invention relate to a configuration that performs information presentation using the degrees of user's interest and a graph structure including nodes and edges, and are suitable for provision of useful information to residents in home.

### REFERENCE SIGNS LIST

1: information presentation device, 2: information providing device, 3: location/activity detecting device, 4: activity predicting device, 5: network, 100: control unit, 101: information obtaining unit, 102: operation history recording unit, 103: operation log analyzing unit, 104: degree-of-interest calculating unit, 105: execution trigger generating unit, 106: graph creating unit, 106a: initial construction unit, 106b: weight updating unit, 107: situation determining unit, 108: presentation content creating unit, 108a: information presenting text creating unit, 108b: screen creating unit, 109: presentation unit, 200: storage unit, 201: location and activity log, 202: user information, 203: activity and room related information, 204: template definitions, 205: information presenting text configuration graph, 206: information structure, 207: operation log, 208: house and device information

1. An information presentation device comprising a processing circuitry
to calculate degrees of interest for each user, for each piece of information in a hierarchical structure, and for each time slot, on a basis of results of analysis of stay time at each node in the hierarchical structure for information obtained when information at each level is presented from a master node to slave nodes in the hierarchical structure;
to generate at least one of a location and an activity serving as a trigger for performing information presentation, as an execution trigger for each user and for each information category;
to create a graph structure in which text templates having variables are stored in nodes and the nodes are connected by edges, set weights of the nodes and the edges, and update the weights of at least one of the nodes and the edges;
to perform determination of whether to perform information presentation, on a basis of the execution trigger and using either one or both of a user's location and activity;
to create information presenting text that uses the graph structure, by extracting some nodes using the graph structure and on a basis of weights of nodes and edges in which degrees of interest of a user and external information which are set per time slot are reflected, and by embedding, when the extracted nodes include variables, information corresponding to degrees of interest in the variables, and construct a screen configuration corresponding to the created information presenting text; and
to perform presentation by voice or on a screen, using the information presenting text.

2. The information presentation device according to claim 1, wherein the determination is performed on a basis of a predicted user's future activity.

3. The information presentation device according to claim 1, wherein the processing circuitry performs processing: to initially construct the graph structure using the text templates; to weight the nodes and the edges on a basis of external information;
to construct a screen configuration corresponding to the created information presenting text, and create, as a presentation content, the information presenting text including external information; and to construct the screen configuration corresponding to the information presenting text, and
the presentation is performed using the screen configuration.

4. The information presentation device according to claim 1, wherein
the graph structure includes three layers which are an introduction part, a main subject, and a supplement part, and
the information presenting text is created by combining nodes in the three layers on a basis of a type of information.

5. An information presentation system comprising: a location/activity detecting device to perform detection of at least one of a location and an activity for each user; and an information presentation device to present information using results of the detection by the location/activity detecting device, wherein
the information presentation device includes a processing circuitry
to calculate degrees of interest for each user, for each piece of information in a hierarchical structure, and for each time slot, on a basis of results of analysis of stay time at each node in the hierarchical structure for information obtained when information at each level is presented from a master node to slave nodes in the hierarchical structure;
to generate at least one of a location and an activity serving as a trigger for performing information presentation, as an execution trigger for each user and for each information category;
to create a graph structure in which text templates having variables are stored in nodes and the nodes are connected by edges, set weights of the nodes and the edges, and update the weights of at least one of the nodes and the edges;
to perform determination of whether to perform information presentation, on a basis of the execution trigger and using either one or both of the location and activity detected by the location/activity detecting device;
to create information presenting text that uses the graph structure, by extracting some nodes using the graph structure and on a basis of weights of nodes and edges in which degrees of interest of a user and external information which are set per time slot are reflected, and by embedding, when the extracted nodes include variables, information corresponding to degrees of interest in the variables, and construct a screen configuration corresponding to the created information presenting text; and
to perform presentation by voice or on a screen, using the information presenting text.

6. An information presentation system comprising: a location/activity detecting device to perform detection of at least one of a location and an activity for each user; an activity predicting device that perform calculation of predicted future activities for each user; and an information presentation device to present information using results of the detection by the location/activity detecting device and results of the calculation by the activity predicting device, wherein
the information presentation device includes a processing circuitry
to calculate degrees of interest for each user, for each piece of information in a hierarchical structure, and for each time slot, on a basis of results of analysis of stay time at each node in the hierarchical structure for information obtained when information at each level is presented from a master node to slave nodes in the hierarchical structure;
to generate at least one of a location and an activity serving as a trigger for performing information presentation, as an execution trigger for each user and for each information category;
to create a graph structure in which text templates having variables are stored in nodes and the nodes are connected by edges, set weights of the nodes and the edges, and update the weights of at least one of the nodes and the edges;
to perform determination of whether to perform information presentation, on a basis of the execution trigger and using at least one of the location and activity detected by the location/activity detecting device and the predicted future activities calculated by the activity predicting device;
to create information presenting text that uses the graph structure, by extracting some nodes using the graph structure and on a basis of weights of nodes and edges in which degrees of interest of a user and external information which are set per time slot are reflected, and by embedding, when the extracted nodes include variables, information corresponding to degrees of interest in the variables, and construct a screen configuration corresponding to the created information presenting text; and
to perform presentation by voice or on a screen, using the information presenting text.

7. The information presentation system according to claim 5, wherein
the processing circuitry performs processing: to initially construct the graph structure using text templates; to weight the nodes and the edges on a basis of external information;
to construct a screen configuration corresponding to the created information presenting text, and create, as a presentation content, the information presenting text including external information; and to construct the screen configuration corresponding to the information presenting text, and
the presentation is performed using the screen configuration.

8. The information presentation system according to claim 5, wherein
the graph structure includes three layers which are an introduction part, a main subject, and a supplement part, and
a presentation content is created by combining nodes in the three layers on a basis of a type of information.
